(19) United States
(12) Patent Application Publication
(10) Pub. No.: US 2013/0313196 A1
(43) Pub. Date: Nov. 28, 2013

(54) PROCESSES AND FILTERS FOR DESALINATION OF WATER

(71) Applicant: TICONA LLC, Florence, KY (US)

(72) Inventors: Julia HUFEN, Rheinberg (DE); Suresh SUBRAMONIAN, Cary, NC (US); Janine BAUER, Duisburg (DE); Kerstin LUEDTKE, Markkleeberg (DE); Jason SMITH, Cincinnati, OH (US); Dian CHEN, Union, KY (US)

(73) Assignee: TICONA LLC, Florence, KY (US)

(21) Appl. No.: 13/887,884

(22) Filed: May 6, 2013

Related U.S. Application Data
(60) Provisional application No. 61/642,914, filed on May 4, 2012.
(60) Provisional application No. 61/791,121, filed on Mar. 15, 2013.

(51) Int. Cl. C02F 1/44

(52) U.S. Cl. CPC C02F 1/441
USPC 210/652; 210/496

(57) ABSTRACT

In a process for the desalination of water, an impure, salt-containing water feed is passed through one or more filter media to remove from the feed impurities having a particle size greater than 50 μm and produce a first filtered water stream. The first filtered water stream is then passed through at least one further filter having an average pore size of 1 μm to 60 μm produced from sintered polyethylene particles having a molecular weight of at least 4×10⁵ g/mol as determined by ASTM-D 4020 to remove at least a portion of the impurities having a particle size less than or equal to 50 μm from the first filtered water stream and produce a second filtered water stream. The second filtered water stream is passed directly to a reverse osmosis membrane to produce a purified water stream.

### FIELD

The present invention relates to processes and filters for the desalination of challenge water and brackish water.

### BACKGROUND

One known method for the desalination of seawater and brackish water is by reverse osmosis through semi-permeable membranes. However, reverse osmosis membranes are very sensitive to the quality of the water they process such that organic components, larger particles and microorganisms can lead to fouling and damage to the membranes. Effective pre-treatment of the water is therefore essential to ensure a satisfactory lifetime for the membrane. In general, the pre-treatment is a multi-stage process in which the water initially passes through stainless steel screens or plastic disc filters for the removal of large particulates, then through a multimedia filter for removal of sand and finer particulates and finally through one or more cartridge filters for the removal of particles of 1 to 50 μm in diameter. Currently, these cartridge filters are produced from polypropylene fibers wound on a core. However these fibers can break and if damaged lose their filtration properties. The filters are not back-washable and so, when clogged they have to be replaced. In fact, depending on water feed quality, existing cartridge filters typically have to be replaced every few days.

According to the present invention, it has now been found that filters produced from sintered high molecular weight polyethylene, HMWPE (generally characterized as polyethylene having a molecular weight of at least 3×10⁵ g/mol and less 1×10⁶ g/mol as determined by ASTM 4020), very-high molecular weight polyethylene, VHMWPE (generally characterized as polyethylene having a molecular weight of at least 1×10⁶ g/mol and less 3×10⁶ g/mol as determined by ASTM 4020), and ultra-high molecular weight polyethylene, UHMWPE (generally characterized as polyethylene having a molecular weight of at least 3×10⁶ g/mol as determined by ASTM 4020), offer advantages over melt blown, string wound and pleated nonwoven cartridge filters in the pre-treatment stage of a reverse osmosis desalination process. The inventive filters are back-washable and more durable than the current polypropylene fiber cartridge filters and so should last from 2 to 6 times as long as the current filters. In addition, by varying the molecular weight and average particle size of the PE employed it is possible to produce filters with differing pore sizes. Moreover, it is possible to produce filters with a pore size gradient tailored to improve the water filtration properties of the filter.

### SUMMARY

In one aspect, the invention resides in a process for the desalination of water, the process comprising:

(a) passing an impure, salt-containing water feed through one or more filter media to remove from the feed impurities having a particle size greater than 50 μm and produce a first filtered water stream;

(b) passing the first filtered water stream through at least one further filter having an average pore size of 1 μm to 60 μm and comprising a porous sintered composition comprising polyethylene particles having a molecular weight of at least 4×10⁵ g/mol as determined by ASTM-D 4020 to remove at least a portion of the impurities having a particle size less than or equal to 50 μm from the first filtered water stream and produce a second filtered water stream; and

(c) passing said second filtered water stream directly to a reverse osmosis membrane to produce a purified water stream.

Typically, the further filter has a porosity of at least 35% and a clean water pressure drop less than 900 mbar, preferably less than 500 mbar.

In one embodiment, the pore size of the further filter varies in the direction of the water flow, wherein the variation can be continuous or stepped.

In one embodiment, the further filter is in the form of a hollow tube having inner and outer walls and the direction of water flow is radial between the inner and outer walls.

In another aspect, the invention resides in a filter for the desalination of water, the filter comprising a hollow tubular body having inner and outer walls arranged such that the direction of water flow is radial between the inner and outer walls, wherein the body is produced from a porous sintered composition comprising polyethylene particles having a molecular weight of at least 4×10⁵ g/mol as determined by ASTM-D 4020 and wherein at least one of the inner and outer walls comprises a plurality of angularly spaced, rigid projections extending along at least part of the length of the body.

In a further aspect, the invention resides in a filter for the desalination of water, the filter comprising a hollow tubular body having inner and outer walls arranged such that the direction of water flow is radial between the inner and outer walls, wherein the body is produced from a porous sintered composition comprising polyethylene particles having a molecular weight of at least 4×10⁵ g/mol as determined by ASTM-D 4020 and wherein the pore size of the sintered composition decreases in the direction of water flow.

Conveniently, the pore size of the sintered composition decreases continuously in the direction of water flow. Alternatively, the pore size of the sintered composition decreases in the direction of water flow in stepwise manner from at least a first large pore size to at least a second, smaller pore size.

Conveniently, the polyethylene particles have a molecular weight up to 10×10⁶ g/mol, such as from 4×10⁵ g/mol to 10×10⁶ g/mol, for example from 6×10⁵ to 10×10⁶, or from 3×10⁶ g/mol to 9×10⁶ g/mol, as determined by ASTM-D 4020.

Generally, the polyethylene particles have an average particle size, d₅₀, from 1 to 500 μm, such as from 30 to 350 μm, for example from 30 to 150 μm.

Generally, the polyethylene particles have a bulk density between 0.1 and 0.5 g/ml.

In one embodiment, the sintered composition also comprises fibers of a material, such as glass fibers, carbon fibers or polymer fibers, having a higher melting point than the polyethylene particles. The fibers may be present in an amount up to 50% by weight, for example from 20 to 40% by weight, of the sintered composition.

In one embodiment, the sintered composition also comprises particles of an adsorptive medium other than polyethylene, wherein the adsorptive medium typically comprises at least one of activated carbon, carbon molecular sieve, diatomaceous earth, silica, zeolite, alumina, an ion exchange resin, titanium silicates, titanium oxides, and metal oxides and hydroxides. For example, the sintered composition may comprise from 99 to 1 wt %, such as from 50 to 10 wt %, of the polyethylene particles and from 1 to 99 wt %, such as from 50 to 90 wt % of the adsorptive medium.

Conveniently, the adsorptive medium comprises activated carbon having a bulk density of between 0.3 and 0.8 g/ml and a BET surface area of about 500 to about 2000 m²/g.

### BRIEF DESCRIPTION OF THE DRAWINGS

FIG. 1 is a flow diagram of a desalination process according to one embodiment of the invention.

FIGS. 2 to 8 are cross-sectional views of tubular sintered polyethylene filter elements suitable for use in the desalination process according to said one embodiment of the invention.

### DETAILED DESCRIPTION OF THE EMBODIMENTS

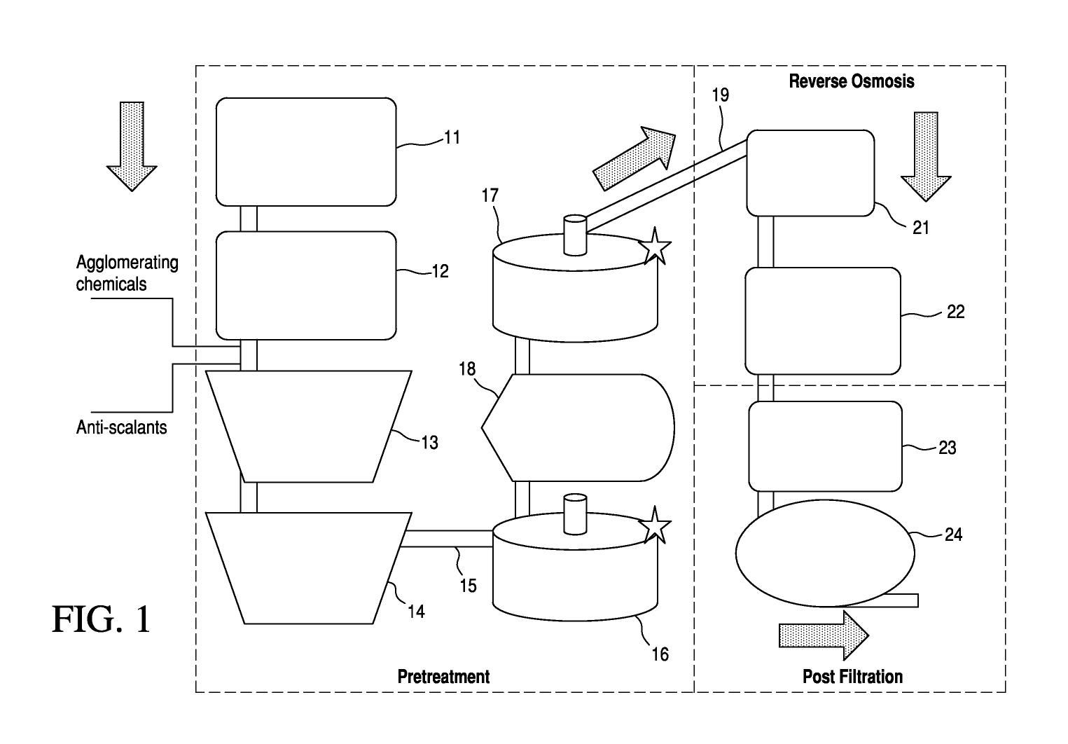

Referring to FIG. 1, in a desalination process according to one embodiment of the invention, an impure, salt-containing water feed 11, such as raw challenge water, is passed through a series of stainless steel screens or plastic disc filters 12 typically having a pore size of 100 mesh. The resultant filtered effluent is then normally mixed with agglomeration agents and anti-scalants and passed through a multimedia filter bed 13 typically composed of sand having a particle size of 350 to 500 μm and anthracite having a particle size of 700 to 800 μm. Optionally, after passage through the multimedia filter 13, the effluent is passed through an additional filter bed 14 formed of granular activated carbon.

The filters 12, 13 and optionally 14 collectively remove particulate impurities having a particle size greater than 50 μm from the water feed 11 and produce a first filtered water stream 15, which is then passed through two sintered polyethylene filters 16, 17 connected in series, optionally with a microfiltration or ultrafiltration system 18 interposed therebetween. Suitable microfiltration and ultrafiltration systems include plate and frame membranes, tubular membranes, hollow fiber membranes, spirally wound membranes made of natural (e.g. modified natural cellulose polymers) or synthetic polymers (e.g. polypropylene, polysulfones and polyvinylidene difluoride) and inorganic ceramic materials with the membrane pore size of 0.01-10 μm. The filters 16, 17 and optionally 18 remove bacteria and solid impurities having a particle size less than or equal to 50 μm from the first filtered water stream 15 and produce a second filtered water stream 19, which is fed directly by high pressure pumps 21 to a reverse osmosis membrane 22. After one or two passes through the membrane a purified water stream is obtained which, after passage through an ion exchanger 23, can be sent to storage as a potable water supply 24.

Each of the filters 16, 17 has an average pore size from 1 μm to 60 μm, such as from 5 μm to 55 μm, for example from 15 to 55 μm, and is composed of a porous sintered composition comprising polyethylene powder having a molecular weight of at least 4×10⁵ g/mol and generally up to 10×10⁶ g/mol, such as from 6×10⁵ g/mol to 10×10⁶ g/mol, for example from 3×10⁶ g/mol to 9×10⁶ g/mol, as determined by ASTM-D 4020. The polyethylene powder may have a monomodal molecular weight distribution or may have a multimodal, generally bimodal, molecular weight distribution. The particle size of the polyethylene powder used to produce the filters can vary significantly but in general the powder has an average particle size, d₅₀, between 1 and 500 μm, such as from 30 to 350 μm, for example from 30 to 150 μm. Where the as-synthesized powder has a particle size in excess of the desired value, the particles can be ground to the desired particle size. The bulk density of the polyethylene powder is typically is between 0.1 and 0.5 g/ml, such as between 0.2 and 0.45 g/ml.

Generally, the filters 16, 17 should have a high porosity, such as at least 35% and preferably at least 40%, and a low pressure drop, such as less than 900 mbar, for example less than 500 mbar, when the filters are initially challenged with clean water. In general the filters should have a flexural strength at determined in accordance with DIN ISO 178 of at least 0.5 MPa.

In one embodiment, the porous sintered composition used to produce the filters 16, 17 not only contains polyethylene but also contains one or more adsorptive media selected from activated carbon, diatomaceous earth, silica, zeolite, alumina, ion exchange resins, titanium silicates, titanium oxides, and metal oxides and hydroxides. Generally, the sintered composition comprises from 99 to 1 wt %, such as from 50 to 10 wt % of the polyethylene particles and from 1 to 99 wt %, such as from 50 to 90 wt % of the adsorptive medium. In one embodiment, the adsorptive medium comprises activated carbon having a bulk density of between 0.3 and 0.8 g/ml and a BET surface area of about 500 to about 2000 m²/g, such as about 800 to about 1500 m²/g.

In addition, the sintered composition may also comprise fibers of a material, such as glass fibers, carbon fibers or polymer fiber, having a higher melting point than the polyethylene particles. The fibers increase the porosity of the filter and reduce the pressure drop across the filter and may be present in an amount up to 50% by weight, for example from 20 to 40% by weight, of the sintered composition.

By virtue of the strength and durability of sintered high molecular weight polyethylene, the filters 16, 17 are back-washable and hence, to avoid the growth or accumulation of potentially harmful viruses or microbes on repeated use and back-washing, it may be desirable to include materials which possess antiviral and/or antimicrobial properties, such as silver salts, in the composition sintered to produce the filters.

In one embodiment, the filters 16, 17 employed in the present process are effective in removing at least 90 wt %, such as at least 95 wt %, of the particles having a size less than or equal to 50 μm, such as from 2 to 50 μm, from a waste water stream, even after repeated back-washing.

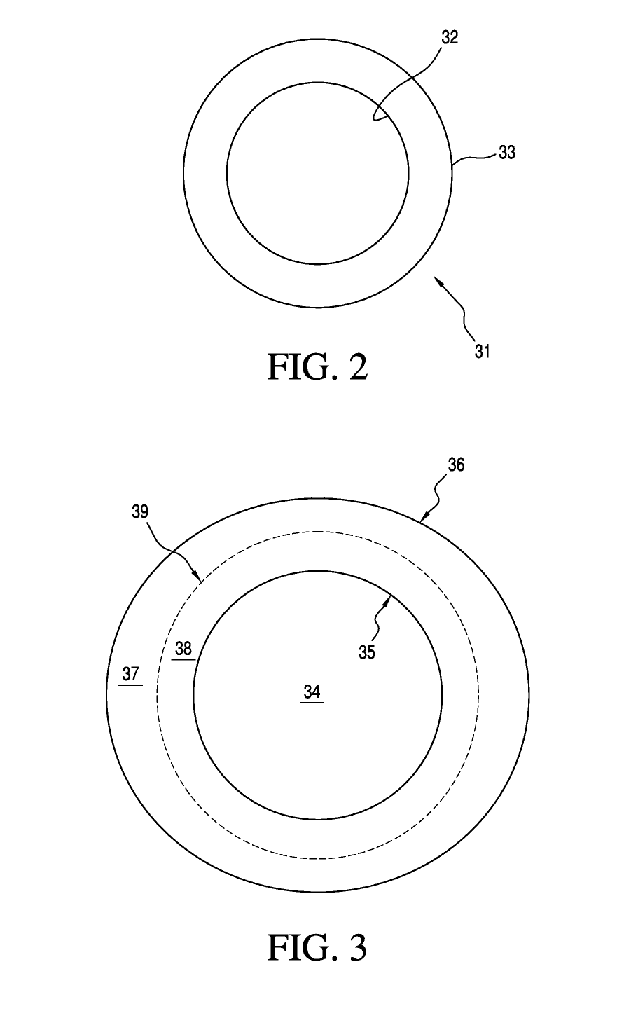

Referring to FIG. 2, each of the filters 16, 17 may be in the form of a single hollow tube 31 having an inner wall 32 and an outer wall 33, with the direction of water flow through the filter being radial from the outer to the inner wall. The tube 31 may have a constant pore size as measured in the direction of the water flow through the filter, or alternatively the pore size of the filter may vary, and in particular decrease, in the direction of the water flow. This variation can be continuous or stepped. A tube configuration having a continuous variation in pore size is readily produced by introducing polyethylene powder having a variety of particle sizes into a suitably shaped mold and then centrifuging the mold so as to cause the larger particles to move towards the outside of the mold. On sintering, the powder with the radially increasing particle size forms the required hollow porous tube with larger pores adjacent the outer wall 33.

An alternate embodiment is shown in FIG. 3, in which the filter again comprises a single hollow tube 34 having an inner wall 35 and outer wall 36 with the direction of water flow through the filter being radial from the outer to the inner wall. However, in this alternate embodiment, the filter comprises outer and inner sections 37 and 38 respectively where the porosity of outer section 37 is greater than that of inner section 38 so as to provide a stepped decrease in porosity in the direction of the water flow. Such a tube configuration is readily produced by introducing a thin cylindrical spacer or sleeve 39 with diameter between that of the inner wall 35 and the outer wall 36 and then filling the outer section 37 with resin particles with higher porosity and the inner section 38 with resin particles of lower porosity. After carefully removing the sleeve, the composite structure is sintered to produce the desired filter with the required stepped porosity decreasing from the outside to the inside of the filter.

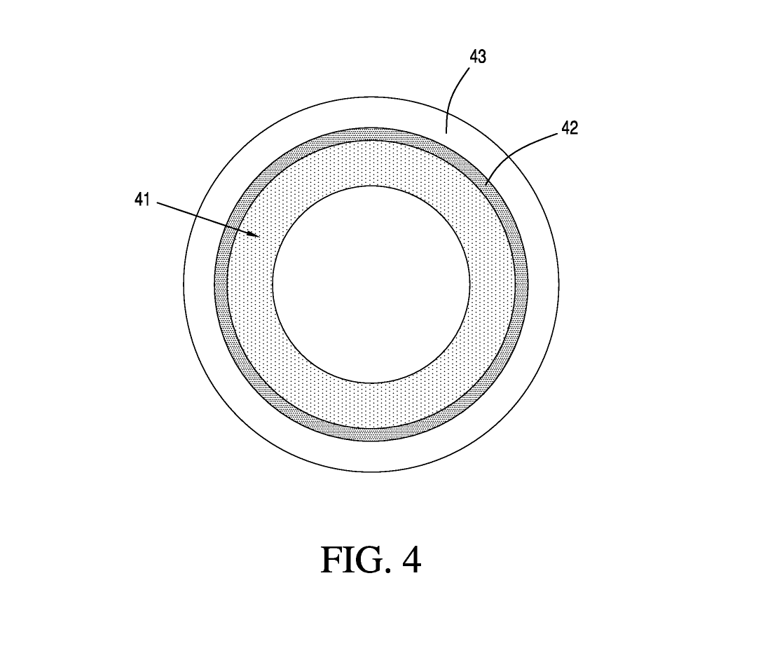

An further embodiment is shown in FIG. 4, in which the filter is in the form of three tubes 41, 42 and 43 of increasing diameter mounted around one another so that the outer wall of the first and innermost tube 41 abuts the inner wall of the second tube 42 and the outer wall of the second tube 42 abuts the inner wall of the third and outermost tube 43. The porosity of the first tube 41 is less than that of the second tube 42, which in turn has a porosity less than that of the third tube 43 so that the porosity of the filter varies in stepped manner in the direction of water flow. Such a filter is readily produced by initially sintering or extruding polyethylene powder to produce the second tube 42 and then placing the tube 42 in a suitable mould having a first annular space inside the inner wall of the tube 42 and a second annular space outside the outer wall of the tube. The first annular space is then filled with polyethylene powder having a smaller particle size than the powder used to produce the tube 42 and the second annular space is filled with polyethylene powder having a larger particle size than the powder used to produce the tube 42. Sintering the composite structure then results in the desired filter with the required stepped porosity decreasing from the outside to the inside of the filter.

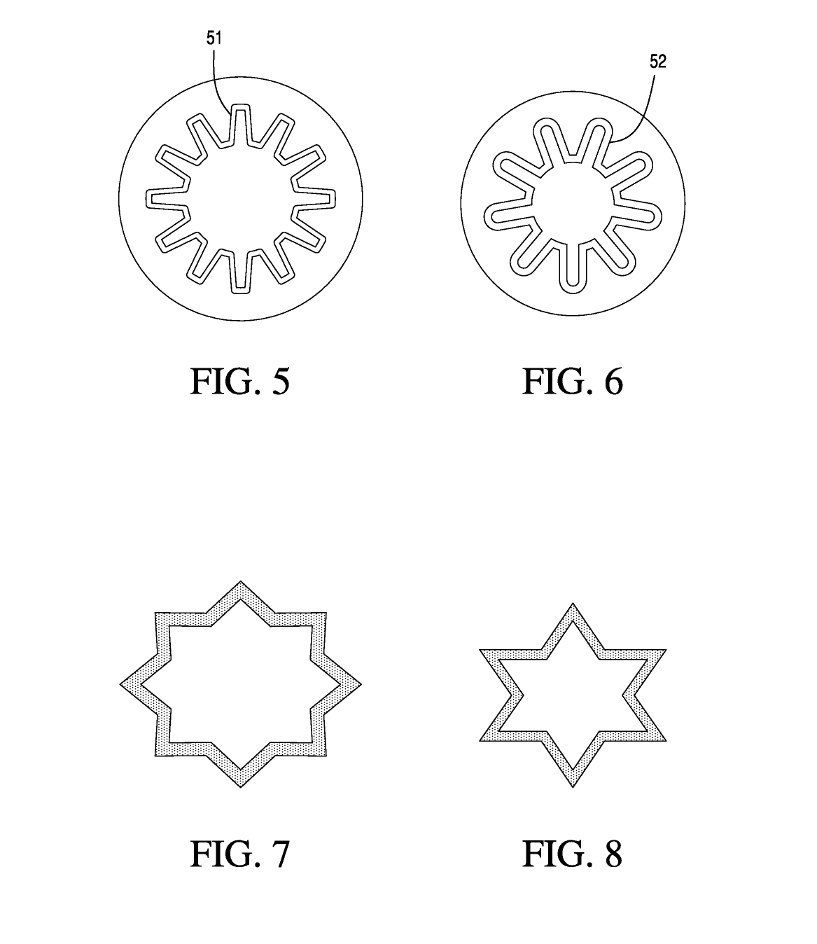

The polyethylene filters shown in FIGS. 2 to 4 are in the form of plain, hollow tubes. However, not only can the filters 16, 17 be other than tubular but, even with tubular filters, at least one of the inner and outer walls of the tube advantageously comprises a plurality of angularly spaced rigid projections extending along at least part of the length of the tube so as to increase the surface to volume ratio of the filter. In particular, it is desirable to arrange that the filter has a surface to volume ratio greater than 5%, such as greater than 10% of an equivalent hollow tubular filter without the above mentioned angularly shaped rigid projections. Examples of suitable filter designs are shown in FIGS. 5 and 6, in which the filters include radially-outwardly extending pleats 52 having parallel walls (FIG. 6) or radially-outwardly extending pleats 51 with walls that converge towards the outer edge of the pleat (FIG. 5). Other suitable filter designs are shown in FIGS. 7 and 8, in which the pleats have a star-shaped cross-section. It will be seen that, although the filters shown in FIGS. 5 to 8 are non-circular in cross-section, they have generally constant wall thickness which is desirable since this facilitates uniform fluid flow through the filter and obviates preferential flow through regions of low pressure drop.

The high molecular weight polyethylene powder is typically produced by the catalytic polymerization of ethylene monomer or optionally with one or more other 1-olefin co-monomers, the 1-olefin content in the final polymer being less or equal to 10% of the ethylene content, with a heterogeneous catalyst and an organo aluminum- or magnesium compound as cocatalyst. The ethylene is usually polymerized in gaseous phase or slurry phase at relatively low temperatures and pressures. The polymerization reaction may be carried out at a temperature of between 50° C. and 100° C. and pressures in the range of 0.02 and 2 MPa.

The molecular weight of the polyethylene can be adjusted by adding hydrogen. Altering the temperature and/or the type and concentration of the co-catalyst may also be used to fine tune the molecular weight. Additionally, the reaction may occur in the presence of antistatic agents to avoid wall fouling and product contamination.

Suitable catalyst systems include but are not limited to Ziegler-Natta type catalysts. Typically Ziegler-Natta type catalysts are derived by a combination of transition metal compounds of Groups 4 to 8 of the Periodic Table and alkyl- or hydrid derivatives of metals from Groups 1 to 3 of the Periodic Table. Transition metal derivatives used usually comprise the metal halides or esters or combinations thereof. Exemplary Ziegler-Natta catalysts include those based on the reaction products of organo aluminum- or magnesium compounds, such as for example but not limited to aluminum- or magnesium alkyls and titanium-, vanadium- or chromium halides or esters. The heterogeneous catalyst might be either unsupported or supported on porous fine grained materials, such as silica or magnesium chloride. Such support can be added during synthesis of the catalyst or may be obtained as a chemical reaction product of the catalyst synthesis itself.

In one embodiment, a suitable catalyst system could be obtained by the reaction of a titanium(IV) compound with a trialkyl aluminum compound in an inert organic solvent at temperatures in the range of −40° C. to 100° C., preferably −20° C. to 50° C. The concentrations of the starting materials are in the range of 0.1 to 9 mol/L, preferably 0.2 to 5 mol/L, for the titanium(IV) compound and in the range of 0.01 and 1 mol/L, preferably 0.02 to 0.2 mol/L for the trialkyl aluminum compound. The titanium component is added to the aluminum component over a period of 0.1 min to 60 min, preferably 1 min to 30 min, the molar ratio of titanium and aluminum in the final mixture being in the range of 1:0.01 to 1:4.

In another embodiment, a suitable catalyst system is obtained by a one or two-step reaction of a titanium(IV) compound with a trialkyl aluminum compound in an inert organic solvent at temperatures in the range of −40° C. to 200° C., preferably −20° C. to 150° C. In the first step the titanium(IV) compound is reacted with the trialkyl aluminum compound at temperatures in the range of −40° C. to 100° C., preferably −20° C. to 50° C. using a molar ratio of titanium to aluminum in the range of 1:0.1 to 1:0.8. The concentrations of the starting materials are in the range of 0.1 to 9.1 mol/L, preferably 5 to 9.1 mol/L, for the titanium(IV) compound and in the range of 0.05 and 1 mol/L, preferably 0.1 to 0.9 mol/L for the trialkyl aluminum compound. The titanium component is added to the aluminum compound over a period of 0.1 min to 800 min, preferably 30 min to 600 min. In a second step, if applied, the reaction product obtained in the first step is treated with a trialkyl aluminum compound at temperatures in the range of −10° C. to 150° C., preferably 10° C. to 130° C. using a molar ratio of titanium to aluminum in the range of 1:0.01 to 1:5.

In yet another embodiment, a suitable catalyst system is obtained by a procedure wherein, in a first reaction stage, a magnesium alcoholate is reacted with a titanium chloride in an inert hydrocarbon at a temperature of 50° to 100° C. In a second reaction stage the reaction mixture formed is subjected to heat treatment for a period of about 10 to 100 hours at a temperature of 110° to 200° C. accompanied by evolution of alkyl chloride until no further alkyl chloride is evolved, and the solid is then freed from soluble reaction products by washing several times with a hydrocarbon.

In a further embodiment, catalysts supported on silica, such as for example the commercially available catalyst system Sylopol 5917 can also be used.

Using such catalyst systems, the polymerization is normally carried out in suspension at low pressure and temperature in one or multiple steps, continuous or batch. The polymerization temperature is typically in the range of 30° C. to 130° C., preferably is the range of 50° C. and 90° C. and the ethylene partial pressure is typically less than 10 MPa, preferably 0.05 and 5 MPa. Trialkyl aluminums, like for example but not limited to isoprenyl aluminum and triisobutyl aluminum, are used as co-catalyst such that the ratio of Al:Ti (co-catalyst versus catalyst) is in the range of 0.01 to 100:1, more preferably is the range of 0.03 to 50:1. The solvent is an inert organic solvent as typically used for Ziegler type polymerizations. Examples are butane, pentane, hexane, cyclohexene, octane, nonane, decane, their isomers and mixtures thereof. The polymer molecular mass is controlled through feeding hydrogen. The ratio of hydrogen partial pressure to ethylene partial pressure is in the range of 0 to 50, preferably the range of 0 to 10. The polymer is isolated and dried in a fluidized bed drier under nitrogen. The solvent may be removed through steam distillation in case of using high boiling solvents. Salts of long chain fatty acids may be added as a stabilizer. Typical examples are calcium-magnesium and zinc stearate.

Optionally, other catalysts such as Phillips catalysts, metallocenes and post metallocenes may be employed. Generally a cocatalyst such as alumoxane or alkyl aluminum or alkyl magnesium compound is also employed. For example, U.S. Patent Application Publication No. 2002/0040113 to Fritzsche et al., the entire contents of which are incorporated herein by reference, discusses several catalyst systems for producing ultra-high molecular weight polyethylene. Other suitable catalyst systems include Group 4 metal complexes of phenolate ether ligands such as are described in International Patent Publication No. WO2012/004675, the entire contents of which are incorporated herein by reference.

The resultant high molecular weight polyethylene powder is formed into the required filters 16, 17 by molding with additional materials optionally being added to the molding powder, depending on the desired properties of the molded article. For example, it may be desirable to combine the polyethylene powder with activated carbon for filtering applications. The powder may also contain additives such as lubricants, dyes, pigments, antioxidants, fillers, processing aids, light stabilizers, neutralizers, antiblock, or the like.

The molded filters may be formed by a free sintering process which involves introducing the molding powder comprising the polyethylene polymer and the optional adsorptive medium into either a partially or totally confined space, e.g., a mold, and subjecting the molding powder to heat sufficient to cause the polyethylene particles to soften, expand and contact one another. Suitable processes include compression molding and casting. The mold can be made of steel, aluminum or other metals.

Sintering processes are well-known in the art. The mold is heated to the sintering temperature, which is normally in the range of about 100° C. to 300° C., such as 140° C. to 300° C., for example 140° C. to 240° C. The mold is typically heated in a convection oven, hydraulic press or by infrared heaters. The heating time will vary and depend upon the mass of the mold and the geometry of the molded article. Typical heating time will lie within the range of about 5 to about 300 minutes, more typically in the range of about 15 minutes to about 100 minutes. The mold may also be vibrated to ensure uniform distribution of the powder.

During sintering, the surface of individual polymer particles fuse at their contact points forming a porous structure. The polymer particles coalesce together at the contact points due to the diffusion of polymer chains across the interface of the particles. The interface eventually disappears and mechanical strength at the interface develops. Subsequently, the mold is cooled and the porous article removed. The cooling step may be accomplished by conventional means, for example it may be performed by blowing air past the article or the mold, or contacting the mold with a cold fluid. Upon cooling, the polyethylene typically undergoes a reduction in bulk volume. This is commonly referred to as “shrinkage.” A high degree of shrinkage is generally not desirable as it can cause shape distortion in the final product.

Pressure may be applied during the sintering process, if desired. However, subjecting the particles to pressure causes them to rearrange and deform at their contact points until the material is compressed and the porosity is reduced. In general, therefore, the sintering process employed herein is conducted in the absence of applied pressure.

In one embodiment, the desalination process illustrated in FIG. 1 has an additional coarse filter (not shown) between multimedia filter 13 and the sintered polyethylene filters 16, 17 for removing coarse particulates from the water feed before it reaches the filters 16, 17. This additional coarse filter typically has an average pore size of greater than 50 μm to 100 μm and can be produced from the same sintered polyethylene as used for the filters 16, 17 but typically with a larger particle size.

The invention will now be more particularly described with reference to the following non-limiting Examples.

In the Examples, and the remainder of the specification, the following tests are used to measure the various parameters cited herein.

Particle size measurements cited herein are average particle size values and are obtained by a laser diffraction method according to ISO 13320.

Polyethylene powder bulk density measurements are obtained according to DIN 53466.

Activated carbon bulk density measurements are obtained according to ASTM D2854.

Activated carbon BET surface area measurements are obtained according to DIN 66131.

Porosity values are determined by mercury intrusion porosimetry according to DIN 66133.

Average pore size values are determined according to DIN ISO 4003.

Pressure drop values are obtained by reading the pressure of the system before the filter and subtracting the pressure of the system after the filter. Initially the pressure drop of each system was recorded using clean water (<2.0 NTU). After this the pressure drop was monitored for each system during the filtration phase of the experiment which utilized the challenge water (50-70 NTU targeted)

In the filter tests described in the Examples, Sil-Co-Sil 106, a fine ground silica powder from US Silica, was added to a clean water sample. The silica was added at a concentration of 0.32-0.44 g/liter of water to achieve a turbidity of 50 to 70 NTU as measured by a Hach 2100P turbidimeter. This water is referred to as the challenge water.

### Examples 1 to 12

### Production of Constant Pore Size Filters of FIG. 2

The commercial HMW, VHMW and UHMW PE resins listed in Table 1 with a range of MW, bulk densities, particle sizes and shapes are used to fabricate sintered filters with a range of pore size, porosity and pressure drop values. Each filter is of a tubular shape as shown in FIG. 2 with a constant pore size as measured in the direction of the water flow, that is between the inner and outer cylindrical walls of the filter.

TABLE 1

| Property | Ex. 1 | Ex. 2 | Ex. 3 | Ex. 4 | Ex. 5 | Ex. 6 | Ex. 7 | Ex. 8 | Ex. 9 | Ex. 10 | Ex. 11 | Ex. 12 |
|---|---|---|---|---|---|---|---|---|---|---|---|---|
| MW | 5 | 4 | 8.1 | 4 | 1.7 | 7 | 4 | 0.6 | 0.7 | 0.5 | 0.5 | 0.47 |
| (10⁶ g/mol) | | | | | | | | | | | | |
| Avg. d50 | 120 | 35 | 60 | 140 | 150 | 175 | 280 | 400 | 120 | 118 | 220 | 120 |
| Particle Size | | | | | | | | | | | | |
| (μm) | | | | | | | | | | | | |
| Bulk | >0.40 | >0.23 | >0.40 | >0.23 | >0.40 | >0.40 | >0.40 | >0.35 | >0.40 | >0.40 | >0.40 | >0.23 |
| Density | | | | | | | | | | | | |
| (g/ml) | | | | | | | | | | | | |
| Avg. Pore | 25 ± 5 | 20 ± 3 | 15 ± 3 | 52 ± 5 | 39 ± 5 | 33 ± 5 | 60 ± 5 | 200 ± 20 | 40 ± 5 | 50 | 130 ± 10 | N/A |
| Size | | | | | | | | | | | | |
| Porosimeter | | | | | | | | | | | | |
| (μm) | | | | | | | | | | | | |
| porosity | 40 ± 5 | 65 ± 5 | 40 ± 5 | 70 ± 5 | 40 ± 5 | 40 ± 5 | 40 ± 5 | 45 ± 5 | 40 ± 5 | 43 | 45 ± 5 | N/A |
| (%) | | | | | | | | | | | | |

### Example 13

### Clean Water Testing of Filters of Examples 1-3

The clean water handling performance of the filters according to Examples 1 to 3 above, each with a constant wall thickness of 1.7 cm, was tested using a mixture of reverse osmosis (RO) permeate and blend water. The clean water was pumped though a manifold connected in parallel to the three filters at a manifold pressure of 3102 mbar and gate valves located at the inlet to each filter were adjusted until flowmeters located at the outlet of each filter indicated the flow rate through the filters was 11.4 L/min. Pressure and flow readings were recorded and are shown in Table 2.

TABLE 2

| Filter | Average Pore size | Flow | Feed Pressure | Pressure Drop |
|---|---|---|---|---|
| Example | (μm) | (L/min) | (mbar) | (psi) |
| 1 | 25 | 11.4 | 2413 | 414 |
| 2 | 20 | 11.4 | 2413 | 621 |
| 3 | 15 | 11.4 | 2413 | 1000 |

### Example 14

### Challenge water Testing of Filters of Examples 1-3

Filters according to Examples 1 to 3 above, each with a constant wall thickness of 1.7 cm, were used to treat the challenge water described above. The challenge water was pumped though a manifold connected in parallel to the three filters such that the manifold pressure was adjusted to 3102 mbar and the flow rate through the filters was adjusted to 11.4 L/min. Once the flow rate and pressure were stabilized, the first set of data was recorded. Pressure drop, flow rate through filter, and manifold flow and pressure were regularly recorded (typically about every two to four minutes). During each experiment, the manifold pressure was held constant at 3102 mbar. The flow rate through each filter began to decrease as the filter began to clog. When this occurred, the flow rate was adjusted back to 11.4 L/min by opening a gate valve ahead of the filter housing inlet. This was a repetitive process as the filter gradually became more and more clogged. Eventually, the gate valve would be completely opened and the flow rate would continue to decrease below 11.4 L/min. This point was recorded for each filter. The test was run until the flow rate through the filter reached below 1.8 L/min. The results are summarized in Table 3.

Simultaneously with the testing of the filters of Examples 1 to 3, the challenge water was also supplied to 5-μm and 20-μm Hytrex® filters supplied by GE Power and Water. Hytrex filters are made of thermally welded blown polypropylene microfibers. The challenge water was pumped though a manifold connected in parallel to the Hytrex filters such that the manifold pressure was adjusted to 827 mbar and the flow rate through the filters was adjusted to 11.4 L/min. As before, the flow rate through the filters was maintained at 11.4 L/min by opening a gate valve as the filters clogged and the test was continued until, with the gate valve fully open, the flow rate through the filter reached below 1.8 L/min. Again the results are summarized in Table 3.

TABLE 3

| | | Max Run | |
|---|---|---|---|
| | Max Flow Rate | Duration | Reason for |
| Filter | (L/min) | (min) | Closing System |
| 5 μm GE Hytrex | 11.4 | 33 | <1.8 L/min |
| 20 μm GE Hytrex | 11.4 | 114 (average) | <1.8 L/min |
| Example 1 | 10.4 | 59 | <1.8 L/min |
| Example 2 | 5.7 | 27 | <1.8 L/min |
| Example 3 | 10.6 | 59 | <1.8 L/min |

A water sample was taken at the inlet and outlet of each filter at the beginning of each experiment after the systems reached a steady flow rate of 11.4 L/min at 3102 mbar (filters of Examples 1-3) or 827 mbar (Hytrex filters) feed pressure. This was typically performed within the first five minutes of operation. Before obtaining a sample of inlet and outlet water, the sample valve was opened and a stream of the sample water was allowed to flow into a bucket. This ensured a representative sample was obtained. Each sample container was rinsed out three times with the sample water, then filled and sealed. A Beckman MS4 Coulter Counter with a 100 μm aperture was used to analyze the particle size distribution of the water samples both going into and coming out of each cartridge filter tested. These analyses were the used to provide data for the calculation of the removal efficiency for each filter. All three of the filters of Examples 1-3 showed about 98% particle removal at the ˜2 μm size rang, whereas the Hytrex 5-1 μm and 20 μm filters removed only about 10-35% of the particles at the ˜2 μm size range.

Turbidity analysis of the effluent from each filter was performed at intervals of about 5-10 minutes throughout each run using a Hach 2100P turbidimeter. In each case, vials specifically made for the turbidimeter were used to collect the samples, with the vials initially being triple rinsed to assure removal of excess silica from previous sampling events. The average turbidity reduction of the effluent from each filter is summarized in Table 4, which gives the result for four separate runs with the filters of Examples 1 to 3 and two separate runs with the Hytrex filters. New GE filters were used each time.

TABLE 4

| Run | GE-5 μm | GE-20 μm | Example 1 | Example 2 | Example 3 |
|---|---|---|---|---|---|
| 1 | 73% | 14% | 99.34% | 99.74% | 99.86% |
| 2 | | | 99.88% | 99.79% | 99.78% |
| 3 | 32.20% | 24.25% | 99.50% | 99.85% | 99.85% |
| 4 | | | 99.81% | 99.63% | 99.89% |

The turbidity reduction with the filters of Examples 1 to 3 was in excess of 99% for each run and was consistent between the runs. The Hytrex filters showed much lower turbidity reduction and a lack of consistency between runs.

### Example 15

### Effect of Wall Thickness on Filter of Example 1

The clean water testing of Example 13 and the challenge water testing of Example 14 was repeated on three filters of Example 1 having wall thicknesses of 1.7 cm (Example 1-1), 1.1 cm (Example 1-2) and 0.5 cm (Example 1-3). Challenge water testing was also conducted with the Hytrex 5-1 μm and 20 μm filters. The results are summarized in Tables 5 to 7 below.

TABLE 5
“Clean” Water Test

| | Wall | Flow | Feed Pressure | Pressure Drop |
|---|---|---|---|---|
| Filter | Thickness (cm) | (L/min) | (mbar) | (mbar) |
| Example 1-1 | 1.7 | 11.4 | 2413 | 483 |
| Example 1-2 | 1.1 | 11.4 | 2413 | 345 |
| Example 1-3 | 0.5 | 11.4 | 2413 | 207 |

TABLE 6
Filter Performance Summary

| | | Max Run | |
|---|---|---|---|
| | Max Flow | Duration | Reason for |
| Filter | Rate (L/min) | (min) | Closing System |
| 5 μm GE Hytrex - Run 1 | 11.4 | 58 | <1.8 L/min |
| 20 μm GE Hytrex - Run 1 | 11.4 | 134 | <1.8 L/min |
| 5 μm GE Hytrex - Run 2 | 11.4 | 27 | <1.8 L/min |
| Example 1-1 | 11.4 | 63 | <1.8 L/min |
| Example 1-2 | 11.4 | 44 | <1.8 L/min |
| Example 1-3 | 11.4 | 32 | collapsed |

TABLE 7
Average Turbidity Reduction

| Run | GE-5 μm | GE-20 μm | Example 1-1 | Example 1-2 | Example 1-3 |
|---|---|---|---|---|---|
| 1 | 76.14% | 24.86% | 99.34% | 99.74% | 99.86% |
| 2 | | | 99.84% | 99.81% | |
| 3 | 50.69% | 74.48% | 99.88% | 99.89% | |
| 4 | | | 99.75% | 99.84% | |

As shown in Tables 5 and 6, the filter of Example 1-3 had the lowest pressure drop with clean water but collapsed during Run 1. This left the filter of Example 1-2 as having the lowest clean water pressure drop (345 mbar) while not collapsing. The filter of Example 1-1 had the longest run time (63 minutes).

As shown in Table 7, all the filters of Example 1 reduced turbidity by greater than 99%, whereas the Hytrex filters showed much lower turbidity reduction and a lack of consistency between runs.

MS4 particle size analysis showed that the GE 5- and 20 μm filters removed less than 30% of the particles at the ˜2 μm size range, whereas all three of the filters of Example 1 showed about 95 to 98% particle removal at the ˜2 μm size range.

The challenge water testing of Example 14 was repeated on a filter of Example 2 having a wall thickness of 1.7 cm and a filter of Example 3 having a wall thickness of 0.5 cm challenge water testing was also conducted with the Hytrex 5-1 μm and 20 μm filters. The results are summarized in Tables 8 and 9 below.

TABLE 8
Filter Performance Summary

| | Max Flow | Max Run | |
|---|---|---|---|
| | Rate | Duration | Reason for |
| Filter | (L/min) | (min) | Closing System |
| 5 μm GE Hytrex - Run 1 | 11.4 | 48 | <1.8 L/min |
| 20 μm GE Hytrex - Run 1 | 11.4 | 74 | <1.8 L/min |
| 5 μm GE Hytrex - Run 2 | 11.4 | 70 | <1.8 L/min |
| 20 μm GE Hytrex - Run 2 | 11.4 | 66 | <1.8 L/min |
| 5 μm GE Hytrex - Runs 3 & 4 | 11.4 | 94 | <1.8 L/min |
| Example 3 (0.5 cm wall) | 10.6 | 32 | <1.8 L/min |
| Example 2 (1.7 cm wall) | 11.4 | 48 | <1.8 L/min |

TABLE 9
Average Turbidity Reduction

| Run | GE-5 μm | GE-20 μm | Example 3 | Example 2 |
|---|---|---|---|---|
| 1 | 16.61% | 55.19% | 99.93% | 99.87% |
| 2 | | | 99.80% | 99.69% |
| 3 | 33.90% | 31.51% | 99.83% | 99.80% |
| 4 | | | 99.83% | 99.87% |

As shown in Table 9, the filters of Examples 2 and 3 reduced turbidity by greater than 99%, whereas the Hytrex filters showed much lower turbidity reduction and a lack of consistency between runs.

MS4 particle size analysis showed that the filters of Examples 2 and 3 provided about 99% particle removal at the ˜2 μm size range, whereas the GE 5- and 20 μm filters removed only about 5-20% of the particles at the ˜2 μm size range.

### Example 16

### Effect of Backwashing

At the conclusion of the initial run for Examples 1-3, a backwash cycle was initiated. The backwash cycle consisted of reversing the flow path of the filtration apparatus, so that water would flow from the inside to the outside of the filter. The backwash was completed using clean water at a head pressure of 1700-2100 mbar, for a targeted flow of 18.9 L/m for 90 seconds.

To evaluate a filter's ability to be repeatedly backwashed, each filter was backwashed up to three times. The change in run time from run 1 to run 4 gives an indication of a filter's backwashability. A large decrease in run times suggests that the filter is clogging in a manner that does not allow trapped particles to escape.

TABLE 10
Backwashability Summary

| Filter | % Change in run time |
|---|---|
| 20 μm GE Hytrex - Run 1 | −71% |
| 5 μm GE Hytrex - Run 2 | −69% |
| Example 3-2 | −42% |
| Example 2-1 | −42% |
| Example 1-1 | −32% |
| Example 1-2 | −30% |
| Example 3-1 | −27% |
| Example 2-2 | −23% |

### Example 17

### Production of Stepped Pore Size Filter of FIG. 4

A filter was produced having the configuration of FIG. 4 and comprising an outer layer composed of the 120 μm UHMWPE used to produce the filter of Example 1, a central layer composed of the 35 μm UHMWPE used to produce the filter of Example 2 and an inner layer composed of the 60 μm UHMWPE used to produce the filter of Example 3. Each layer had a wall thickness of about 0.5 cm. Thus the overall filter exhibited a stepped decrease in pore size in the direction of the water flow.

### Example 18

### Testing of Filter of Example 17

The stepped pore size filter of Example 17 and the filters of Examples 2 and 3 with a wall thickness of 1.7 cm were subjected to clean water testing of Example 13 and the challenge water testing of Example 14. Challenge water testing was also conducted with the Hytrex 5-1 μm and 20 μm filters. The results are summarized in Tables 10 to 12 below.

TABLE 10
“Clean” Water Test

| | Flow | Feed Pressure | Pressure Drop |
|---|---|---|---|
| Filter | (L/min) | (mbar) | (mbar) |
| Example 17 | 11.4 | 2275 | 896 |
| Example 3 | 11.4 | 2275 | 861 |
| Example 2 | 11.4 | 2275 | 482 |

TABLE 11
Filter Performance Summary

| | Max Flow | Max Run | |
|---|---|---|---|
| | Rate | Duration | Reason for |
| Filter | (L/min) | (min) | Closing System |
| 5 μm GE Hytrex - Run 1 | 11.4 | 24 | <1.8 L/min |
| 20 μm GE Hytrex - Run 1 | 11.4 | 27 | <1.8 L/min |
| 5 μm GE Hytrex - Run 2 | 11.4 | 47 | <1.8 L/min |
| 20 μm GE Hytrex - Run 2 | 11.4 | 141 | <1.8 L/min |
| Example 17 | 11.4 | 57 | <1.8 L/min |
| Example 3 | 11.4 | 42 | <1.8 L/min |
| Example 2 | 5.7 | 20 | <1.8 L/min |

TABLE 12
Average Turbidity Reduction

| | GE- | GE- | Example | | |
|---|---|---|---|---|---|
| Run | 5 μm | 20 μm | 17 | Example 3 | Example 2 |
| 1 | | | 96.62% | 99.93% | 99.85% |
| 2 | 31.54% | 7.45% | 98.77% | 99.78% | 99.71% |
| 3 | | 17.56% | 95.56% | 99.88% | 99.87% |
| 4 | 55.50% | 3.26% | 97.62% | 99.77% | 99.68% |

As shown in Tables 10 and 11, the filter of Example 2 had the lowest pressure drop (7 psi) with clean water, whereas the filter of Example 17 had the longest run time (57 minutes) of the UHMW-PE filters.

As shown in Table 12, all the filters of Examples 2, 3 and 17 reduced turbidity by greater than 95%, whereas the Hytrex filters showed much lower turbidity reduction and a lack of consistency between runs.

MS4 particle size analysis showed that the filter of Example 3 removed about 98% of the particles at the ˜2 μm size range, the filter of Example 17 removed about 95% of the particles at the ˜2 μm size range and the filter of Example 2 removed about 90% of the particles at the ˜2 μm size range. In contrast, the GE 5 μm filter removed about 50-70% of the particles at the ˜2 μm size range, whereas the GE 20 μm filter removed about 0-15% of the particles at the ˜2 μm size range.

### Example 19

### Testing of Filter of Example 4

The clean water testing of Example 13 and the challenge water testing of Example 14 was repeated on the filter of Example 4 having wall thicknesses of 1.1 cm and in comparison with the filter of Example 17 and the filter of Example 3 having wall thicknesses of 1.7 cm. Challenge water testing was also conducted with the Hytrex 5-1 μm and 20 μm filters. The results are summarized in Tables 13 to 15 below.

TABLE 13
“Clean” Water Test

| | Flow | Feed Pressure | Pressure Drop |
|---|---|---|---|
| Filter | (L/min) | (mbar) | (mbar) |
| Example 17 | 11.4 | NA | 1069 |
| Example 3 | 11.4 | NA | 1276 |
| Example 4 | 11.4 | NA | 1379 |

TABLE 14
Filter Performance Summary

| | Max Flow | Max Run | |
|---|---|---|---|
| | Rate | Duration | Reason for |
| Filter | (L/min) | (min) | Closing System |
| 5 μm GE Hytrex - Run 1 | 11.4 | 68 | <1.8 L/min |
| 20 μm GE Hytrex - Run 1 | 11.4 | 139 | <1.8 L/min |
| 5 μm GE Hytrex - Run 2 | 11.4 | 50 | <1.8 L/min |
| 20 μm GE Hytrex - Run 2 | 11.4 | 51 | <1.8 L/min |
| Example 17 | 11.4 | 57 | <1.8 L/min |
| Example 3 | 11.4 | 51 | <1.8 L/min |
| Example 4 | 11.4 | 71 | <1.8 L/min |

TABLE 15
Turbidity Reduction

| | GE- | | | | |
|---|---|---|---|---|---|
| Run | 5 μm | GE-20 μm - run 1 | Example 17 | Example 3 | Example 4 |
| 1 | 40.11% | 10.95% | 99.78% | 99.76% | 97.75% |
| 2 | | | 99.70% | 99.84% | 97.46% |
| 3 | 89.82% | 86.19% | 99.78% | 99.79% | 98.97% |
| 4 | | | 99.54% | 99.82% | 96.43% |

As shown in Tables 13 and 14, the filter of Example 4 had the highest pressure drop (1379 mbar) with clean water, but had the longest run time (71 minutes) of the UHMW-PE filters.

As shown in Table 15, all the filters of Examples 3, 4 and 17 reduced turbidity by greater than 95%, whereas the Hytrex filters showed lower turbidity reduction and a lack of consistency between runs.

MS4 particle size analysis showed that the filters of Examples 3, 4 and 17 removed about 95-98% of the particles at the ˜2 μm size range, whereas the GE 5 μm filter removed about 30-50% of the particles at the ˜2 μm size range, whereas the GE 20 μm filter removed about 0-20% of the particles at the ˜2 μm size range.

### Examples 20 and 21

### Production of Glass Fiber Containing Filters

The UHMW-PE resin used to produce the filter of Example 4 was combined with glass fibers and sintered to produce filters containing 30 wt % of glass fibers (Example 20) and 50 wt % of glass fibers (Example 21). The filters were of the tubular shape shown in FIG. 2 with a wall thickness of 1.1 cm and a constant pore size in the direction of water flow.

### Example 22

### Testing of Filters of Examples 20 and 21

The clean water testing of Example 13 and the challenge water testing of Example 14 was repeated on the filter of Examples 20 and 21 and the results are summarized in Tables 16 to 18 below.

TABLE 16
“Clean” Water Test

| | | | Pressure |
|---|---|---|---|
| | Flow | Feed Pressure | Drop |
| Filter | (L/min) | (mbar) | (mbar) |
| Example 20 | 11.4 | 3102 | 276 |
| Example 21 | 11.4 | 3102 | 0 |

TABLE 17
Filter Performance Summary

| | Max Flow | Max Run | |
|---|---|---|---|
| | Rate | Duration | Reason for Closing |
| Filter | (L/min) | (min) | System |
| Example 20 | 11.4 | 45 | <1.8 L/min |
| Example 21 | 11.4 | 45 | Turbidity In = Out |

TABLE 18
Average Turbidity Reduction

| Run | Example 20 | Example 21 |
|---|---|---|
| 1 | 97.70% | 33.98% |
| 2 | 97.95% | 26.19% |
| 3 | 98.57% | 23.68% |

As shown in Tables 16 and 17, the filter of Example 21 had the lower clean water pressure drop (0 psi) but the turbidity reduction decreased with time. The filter of Example 20 had a pressure drop of only 276 mbar with clean water and a run time of 45 minutes.

As shown in Table 18, the filter of Example 20 reduced turbidity by over 97%, which operation was consistent even after back-washing. The turbidity reduction with the filter of Example 21 was higher (up to 71%) at the beginning of a run but decreased throughout the run (to around 10%). No visible cracks were observed in the filter.

MS4 particle size analysis showed that the filter of Example 20 removed about 95% of the particles at the ˜2 μm size range, whereas the filter of Example 21 removed about 40-60% of the particles at the ˜2 μm size range.

1. A process for the desalination of water, the process comprising:
(a) passing an impure, salt-containing water feed through one or more filter media to remove from the feed impurities having a particle size greater than 50 μm and produce a first filtered water stream;
(b) passing the first filtered water stream through at least one further filter having an average pore size from 1 μm to 60 μm and comprising a porous sintered composition comprising polyethylene particles having a molecular weight of at least 4×10⁵ g/mol as determined by ASTM-D 4020 to remove at least a portion of the impurities having a particle size less than or equal to 50 μm from the first filtered water stream and produce a second filtered water stream; and
(c) passing said second filtered water stream directly to a reverse osmosis membrane to produce a purified water stream.

2. The process of claim 1, wherein the polyethylene particles have a molecular weight up to 10×10⁶ g/mol, preferably from 3×10⁶ to 9×10⁶ g/mol, as determined by ASTM-D 4020.

3. The process of claim 1, wherein the polyethylene particles have an average particle size, d₅₀, from 1 to 500 μm.

4. The process of claim 3, wherein the polyethylene particles have an average particle size, d₅₀, between 30 and 350 μm.

5. The process of claim 1, wherein the polyethylene particles have a bulk density between 0.1 and 0.5 g/ml.

6. The process of claim 1, wherein the porous sintered composition further comprises an adsorptive medium

7. The process of claim 6, wherein the porous sintered composition is activated carbon.

8. The process of claim 1, wherein the porous sintered composition further comprises fibers of a material having a higher melting point than the polyethylene particles.

9. The process of claim 8, wherein the fibers comprise up to 50% by weight of the sintered composition.

10. The process of claim 9, wherein the fibers comprise from 20 to 40% by weight of the sintered composition.

11. The process of claim 1, wherein the further filter has a porosity of at least 35%.

12. The process of claim 1, wherein the at least one further filter has a clean water pressure drop less 900 mbar, preferably less than 500 mbar.

13. The process of claim 1, wherein the at least one further filter has an average pore size from 5 μm to 55 μm

14. The process of claim 13, wherein the at least one further filter has an average pore size from 15 μm to 55 μm.

15. The process of claim 1, wherein the at least one further filter removes at least 90 wt % of the impurities having a particle size less than or equal to 50 μm from the first filtered water stream.

16. The process of claim 1, wherein the pore size of the further filter decreases in the direction of the water flow.

17. The process of claim 1, wherein the further filter is in the form of a hollow tube having inner and outer walls and the direction of water flow is radial between the inner and outer walls.

18. A filter for the desalination of water, the filter comprising a hollow tubular body having inner and outer walls arranged such that the direction of water flow is radial between the inner and outer walls, wherein the body is produced from a porous sintered composition comprising polyethylene particles having a molecular weight of at least 4×10⁵ g/mol as determined by ASTM-D 4020 and wherein at least one of the inner and outer walls comprises a plurality of angularly spaced, rigid projections extending along at least part of the length of the body.

19. A filter for the pretreatment of desalination of water by reverse osmosis, the filter comprising a hollow tubular body having inner and outer walls arranged such that the direction of water flow is radial between the inner and outer walls, wherein the body is produced from a porous sintered composition comprising polyethylene particles having a molecular weight of at least 4×10⁵ g/mol as determined by ASTM-D 4020 and wherein the pore size of the sintered composition decreases in the direction of water flow.
